(19) United States
(12) Patent Application Publication
(10) Pub. No.: US 2007/0004387 A1
(43) Pub. Date: Jan. 4, 2007

(54) Sharing of services between a mobile computer and a wireless device

(76) Inventors: Uma M. Gadamsetty, Chandler, AZ (US); Vijay M. Rao, Portland, OR (US); Shreekant S. Thakkar, Portland, OR (US); Kristoffer D. Fleming, Chandler, AZ (US); Hani Elgebaly, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,841

(22) Filed: Jun. 30, 2005

(51) Int. Cl. H04Q 7/38

(52) U.S. Cl. 455/414.1; 455/41.2

(57) ABSTRACT

Techniques for sharing services between electronic devices. In response to a specified input condition, determining whether a remote wireless-enabled device is within range of a local device. The local device being configured to communicate using a first communications protocol and the remote device being configured to communicate over a network using a second communications protocol. Establishing a connection between the local device and the remote device using a third communications protocol. Performing discovery operations to determine services available from the remote device. Generating a graphical representation on the local device of the services available from the remote device.

### TECHNICAL FIELD

Embodiments of the invention relate to wireless communications. More particularly, embodiments of the invention relate to techniques for sharing of services between a mobile computer and a wireless device using wireless communication protocols.

### BACKGROUND

Currently, there exist short-range radio protocols that allow wireless devices to communicate. These protocols include, for example, the well-known Bluetooth standards. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

Current uses for Bluetooth include allowing a cellular telephone that is capable of sending and/or receiving electronic mail and/or maintain a calendar to synchronize with a computer system having corresponding e-mail and/or calendar functionality.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an electronic device and a wireless device configured to communicate via a wireless link.

FIG. 2 is a flow diagram of one embodiment of a technique for an electronic device and a wireless device to share services.

FIG. 3 is an illustration of an example user interface that may be presented by a wireless device configured to share services with an electronic device.

FIG. 4 is a block diagram of one embodiment of an electronic system.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

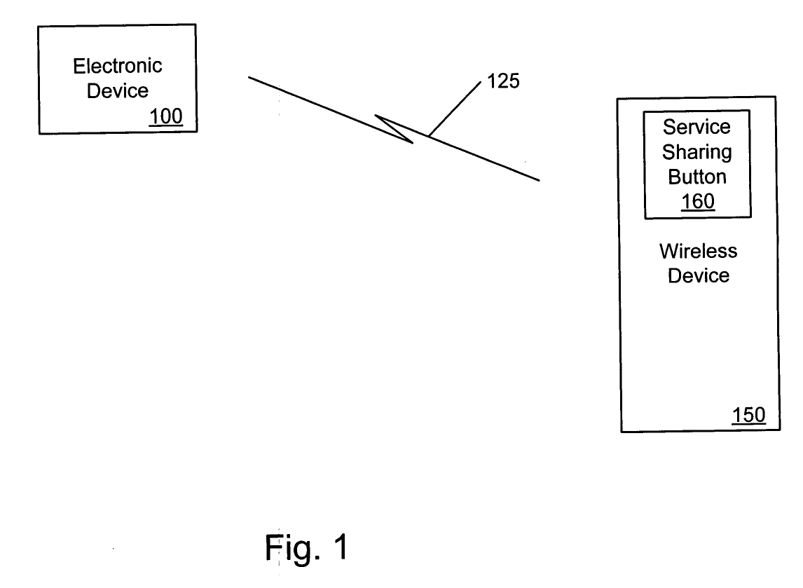

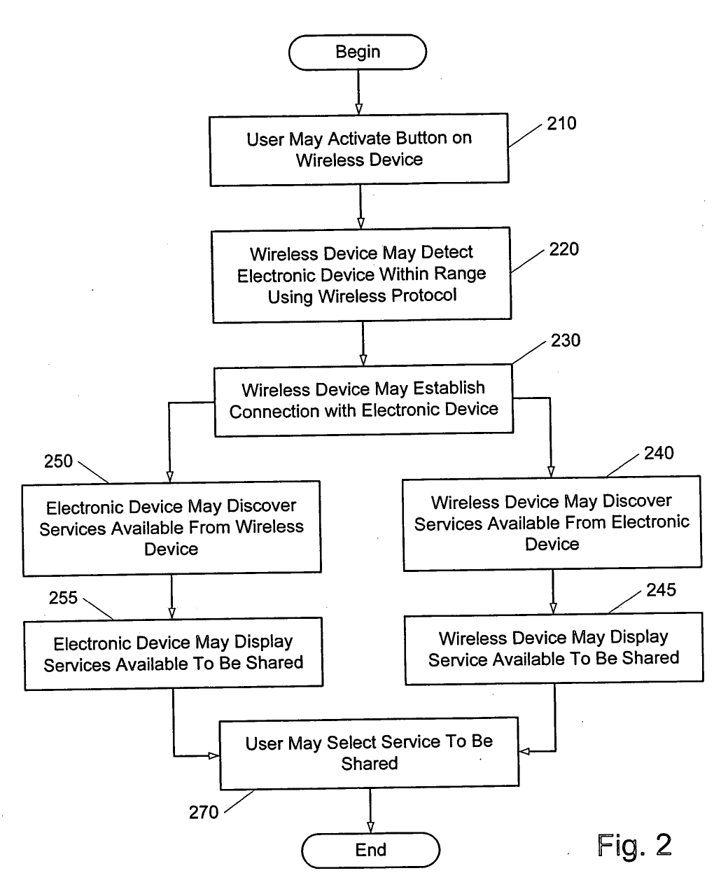

FIG. 1 is a block diagram of one embodiment of an electronic device and a wireless device configured to communicate via a wireless link. The example of FIG. 1 is described in terms of electronic device 100 being a mobile computer system and wireless device 150 being a cellular-enabled communications device and the wireless link between electronic device 100 and wireless device 150 being a Bluetooth communications link. However, FIG. 2 is merely an example and other electronic devices, wireless devices and wireless communications links may also be supported without departing from the intended scope of various embodiments of the invention.

In one embodiment, electronic device 100 is a mobile computer system or other electronic device that supports wireless communications functionality. In one embodiment, electronic device 100 supports both wireless local area network (WLAN) connectivity as well as personal area network (PAN) connectivity. In addition to wireless connectivity, electronic device 100 may also provide wired connectivity to a local area network (LAN), device peripherals, peer-to-peer networking, or any other type of access to remote resources. Wired connectivity is known in the art and may be offered as an optional feature.

In one embodiment, the WLAN connectivity may be provided, for example, by conforming to IEEE 802.11b and/or IEEE 802.11g standards, and the personal area network connectivity may be provided, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents.

In one embodiment, wireless device 150 is a cellular-enabled communications device such as, for example, a cellular telephone, a “smart” phone, etc. Wireless device 150 may be configured to support PAN connectivity as well as cellular communications connectivity, which may include, for example, Time Division, Multiple Access (TDMA) protocols, Global System for Mobile Communications (GSM) protocols, Code Division, Multiple Access (CDMA) protocols, and/or any other type of wireless communications protocol.

In one embodiment, wireless device 150 includes a designated button (e.g., service sharing button 160) that may be used to initiate service sharing with electronic device 100. In response to a user pressing service sharing button 160 (e.g., a single press of the botton), wireless device 150 may, for example, initiate PAN communications with electronic device 100 to engage in service sharing between electronic device 100 and wireless device 150. Service sharing button 160 may be a physical button or switch having a dedicated functionality or may be a soft button that is configurable, for example, by software, to provide functionality based on various conditions.

Service sharing may include, for example, Extended Mobile Access (EMA), Voice Over Internet Protocol (VoIP) using resources of electronic device 100, sharing of data stored on a SIM card, or other static storage device, of wireless device 150. Other services may also be shared in a similar manner.

FIG. 2 is a flow diagram of one embodiment of a technique for an electronic device and a wireless device to share services. The example of FIG. 2 is described in terms of a user of a wireless device pressing a button. The technique of FIG. 2 may be performed in response to a user action other than pressing a button. For example, the user may select an option from a display, or the user may offer a voice command.

A user may activate a button or other input mechanism on a wireless device, 210. The wireless device may be, for example, a cellular telephone or other cellular-enabled device, a personal digital assistant (PDA), a palm-top computer, etc. In response to the button activation, the wireless device may detect an electronic device within range, 220. In one embodiment, the wireless device may use a Bluetooth or other wireless protocol to communicate with the electronic device. Communication with multiple electronic devices may also be supported. The electronic devices may be, for example, a laptop computer system, a desktop computer system, a kiosk, or any other electronic device capable of wireless communications that may provide one or more services not available via the wireless device alone.

Upon detecting the electronic device, the wireless device may establish a wireless connection with the electronic device, 230. The connection may be established automatically in response to detection of the electronic device, or the connection may be established in response to a confirmation input from the user, which may improve security. After the connection has been established, discovery operations may be performed. In the description of FIG. 2, discovery operations are performed on the wireless device and the electronic device; however, in various embodiments, either one or both of these discovery operations may be performed.

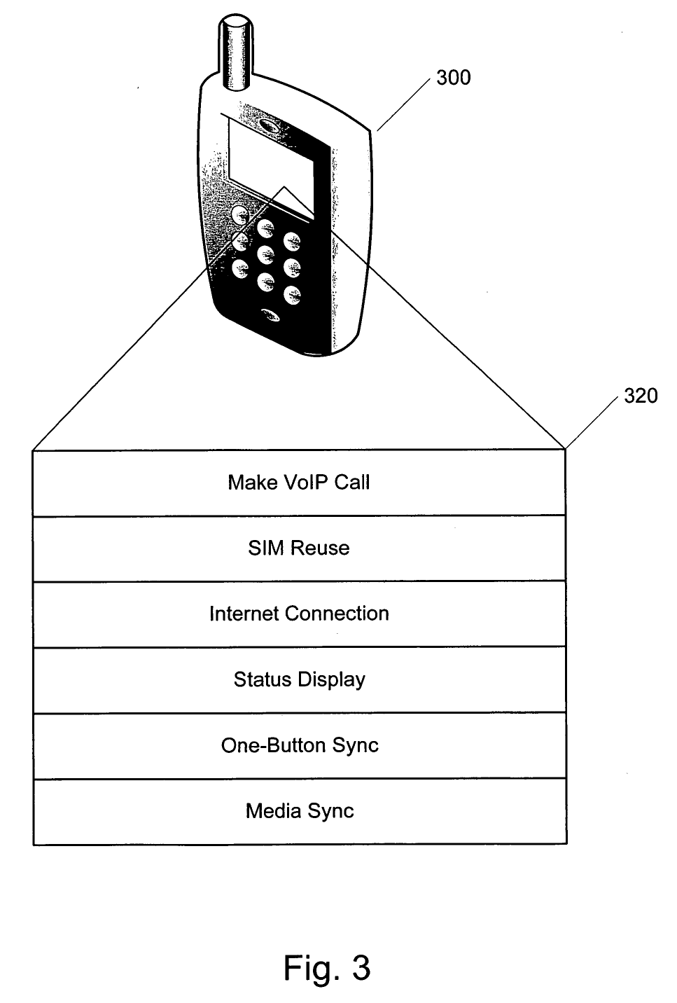

The wireless device may discover services that may be available from the electronic device, 240. In one embodiment, Universal Plug and Play (UPnP) protocols may be used to discover services available from the electronic device. Various UPnP protocols are available from the UPnP Implementers Corp. Other discovery techniques may also be used. When the services available to be shared via the electronic device have been discovered, the services may be displayed by the wireless device, 245. One embodiment, of such a display is illustrated in FIG. 3 and described in greater detail below.

In one embodiment, the electronic device may discover services that may be available from the wireless device device, 250. In one embodiment, UPnP protocols may be used to discover services available from the electronic device. Other discovery techniques may also be used. When the services available to be shared via the wireless device have been discovered, the services may be displayed by the electronic device, 255.

The user may select a service to share between the wireless device and the electronic device, 270.

FIG. 3 is an illustration of an example user interface that may be presented by a wireless device configured to share services with an electronic device. The services described with respect to FIG. 3 are merely a sampling of the services that may be shared between a wireless device and an electronic device.

In one embodiment, after performing discovery operations, the wireless device (illustrated, as an example, in FIG. 3 as a cellular telephone) may provide a listing of available services. These services may include, for example, the ability to make a Voice over IP (VoIP) call using the wireless device as a handset and the electronic device to provide the IP connection. The wireless device may connect to the electronic device using a Bluetooth or other wireless protocol.

As another example, a SIM card in the wireless device may be shared with the electronic device. For example, names and/or phone numbers stored in the SIM card on the wireless device may be accessible by the electronic device. The information may be used, for example, to synchronize an address book or to place a call. The wireless device may also be allowed to share a network connection using the electronic device as the connection to the network.

The user may be able to select a status display that may provide status information for the electronic device and/or the wireless device on a small screen with buttons for navigation. For example, the display of the wireless device may be configured to display status information corresponding to the electronic device including, for example, network information, battery information, calendar information or other messages, electronic system sub-system information, etc.

The shared service may also include synchronization services. For example, a single button (or other input mechanism) may be used to synchronize multiple data sets. For example, a calendar, contact information, electronic mail, and other data may be synchronized between the wireless device and the electronic device in response to the user selecting the “one-button sync” option. Another synchronization option may provide the ability to synchronize media including, for example, audio and/or video programming. For example, audio and/or video programming may be updated or modified.

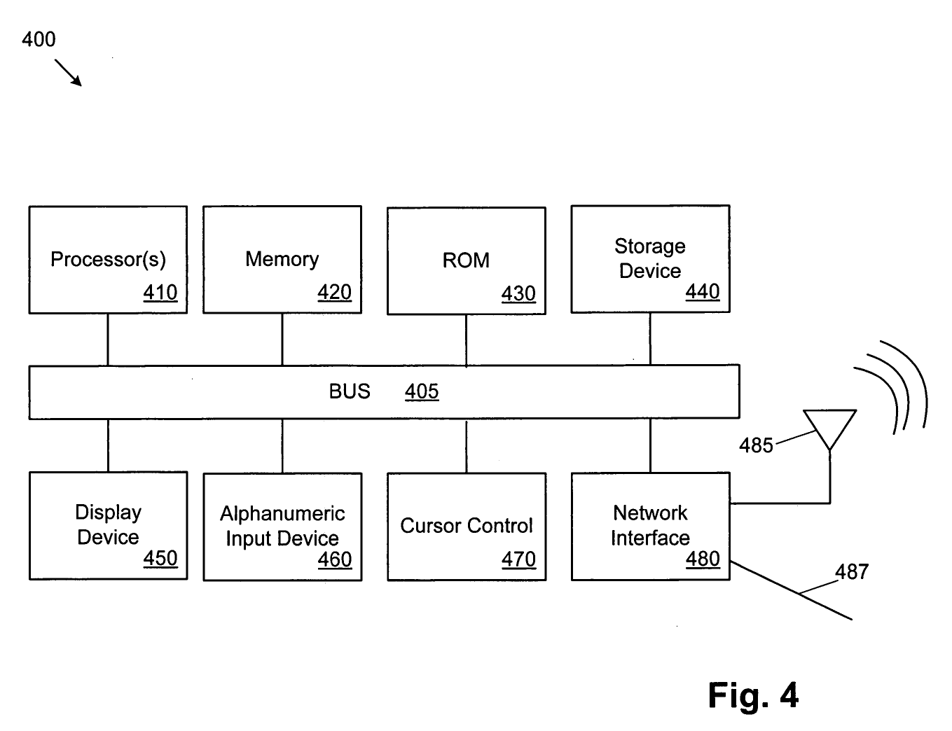

FIG. 4 is a block diagram of one embodiment of an electronic system. The electronic system illustrated in FIG. 4 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components.

Electronic system 400 includes bus 405 or other communication device to communicate information, and processor 410 coupled to bus 405 that may process information. While electronic system 400 is illustrated with a single processor, electronic system 400 may include multiple processors and/or co-processors. Electronic system 400 further may include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Electronic system 400 may also include read only memory (ROM) and/or other static storage device 430 coupled to bus 405 that may store static information and instructions for processor 410. Data storage device 440 may be coupled to bus 405 to store information and instructions. Data storage device 440 such as a magnetic disk or optical disc and corresponding drive may be coupled to electronic system 400.

Electronic system 400 may also be coupled via bus 405 to display device 450, such as a cathode ray tube (CRT) or liquid crystal display (LCD), to display information to a user. Alphanumeric input device 460, including alphanumeric and other keys, may be coupled to bus 405 to communicate information and command selections to processor 410. Another type of user input device is cursor control 470, such as a mouse, a trackball, or cursor direction keys to communicate direction information and command selections to processor 410 and to control cursor movement on display 450.

Electronic system 400 further may include network interface(s) 480 to provide access to a network, such as a local area network. Network interface(s) 480 may include, for example, a wireless network interface having antenna 485, which may represent one or more antenna(e). In addition to, or instead of, communication via wireless LAN standards, network interface(s) 480 and antenna 485 may provide wireless communications using, for example, Time Division, Multiple Access (TDMA) protocols, Global System for Mobile Communications (GSM) protocols, Code Division, Multiple Access (CDMA) protocols, and/or any other type of cellular communications protocol. Network interface(s) 480 may also include, for example, a wired network interface to communicate with remote devices via network cable 487, which may be, for example, an Ethernet cable, a coaxial cable, a fiber optic cable, a serial cable, or a parallel cable.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
in response to a specified input condition, determining whether a remote wireless-enabled device is within range of a local device, wherein the local device is configured to communicate using a first communications protocol and the remote device is configured to communicate over a network using a second communications protocol;
establishing a connection between the local device and the remote device using a third communications protocol;
performing discovery operations to determine services available from the remote device;
generating a graphical representation on the local device of the services available from the remote device.

2. The method of claim 1 wherein the specified input condition comprises a user activating a button.

3. The method of claim 2 wherein the button comprises a physical button.

4. The method of claim 2 wherein the button comprises a soft button.

5. The method of claim 1 wherein the local device comprises a cellular-enabled device and the remote device comprises a computer system.

6. The method of claim 5 wherein the cellular-enabled device comprises a cellular telephone.

7. The method of claim 5 wherein the computer system comprises a mobile computer system.

8. The method of claim 1 wherein the third communications protocol conforms to a Bluetooth standard protocol.

9. The method of claim 1 further comprising sharing a service using the local device and the remote device in response to selection of one of the services from the graphical representation.

10. The method of claim 9 wherein the shared service comprises initiating a Voice over IP (VoIP) call using the local device as a handset and the remote device to provide access to an IP-enabled network.

11. The method of claim 9 wherein the shared service comprises providing network access using a browser on the local device and accessing the network using the remote device.

12. The method of claim 9 wherein the shared service comprises displaying status of one or more characteristics of the remote device on a display of the local device.

13. The method of claim 9 wherein the shared service comprises access to a wireless wide area network (WWAN) by the local device via the remote device.

14. The method of claim 9 wherein the shared service comprises synchronization of data between the local device and the remote device.

15. The method of claim 9 wherein the shared service comprises using a static storage component of the local device to use Voice Over Internet Protocol (VoIP) to utilize one or more network services.

16. The method of claim 15 wherein utilization of the one or more network services comprises simultaneous voice and data access.

17. An article comprising a computer-readable medium having stored therein instructions that, when executed, cause one or more processing systems to:
in response to a specified input condition, determine whether a remote wireless-enabled device is within range of a local device, wherein the local device is configured to communicate using a first communications protocol and the remote device is configured to communicate over a network using a second communications protocol;
establish a connection between the local device and the remote device using a third communications protocol;
perform discovery operations to determine services available from the remote device;
generate a graphical representation on the local device of the services available from the remote device.

18. The article of claim 17 wherein the specified input condition comprises a user activating a button.

19. The article of claim 17 wherein the button comprises a physical button.

20. The article of claim 17 wherein the button comprises a soft button.

21. The article of claim 17 wherein the local device comprises a cellular-enabled device and the remote device comprises a computer system.

22. The article of claim 21 wherein the cellular-enabled device comprises a cellular telephone.

23. The article of claim 21 wherein the computer system comprises a mobile computer system.

24. The article of claim 17 wherein the third communications protocol conforms to a Bluetooth standard protocol.

25. The article of claim 17 further comprising instructions that, when executed, cause the one or more processing systems to share a service using the local device and the remote device in response to selection of one of the services from the graphical representation.

26. The article of claim 25 wherein the shared service comprises a Voice over IP (VoIP) call using the local device as a handset and the remote device to provide access to an IP-enabled network.

27. The article of claim 25 wherein the shared service comprises network access using a browser on the local device and accessing the network using the remote device.

28. The article of claim 25 wherein the shared service comprises display of status of one or more characteristics of the remote device on a display of the local device.

29. The article of claim 25 wherein the shared service comprises access to a wireless wide area network (WWAN) by the local device via the remote device.

30. The article of claim 25 wherein the shared service comprises synchronization of data between the local device and the remote device.

31. The article of claim 25 wherein the shared service comprises using a static storage component of the local device to use Voice Over Internet Protocol (VoIP) to utilize one or more network services.

32. The article of claim 31 wherein utilization of the one or more network services comprises simultaneous voice and data access.

33. An apparatus comprising:
a first transceiver to communicate using a cellular communications protocol;
a second transceiver to communicate using a short-range wireless communications protocol;
a button;
a processor coupled with the first transceiver, with the second transceiver and with the button to determine whether a remote device capable communicating using the short range wireless communications protocol is within range in response to activation of the button, wherein the processor causes discovery operations to be performed on the remote device, if any, to determine whether the remote device is capable of sharing services; and
a display device coupled with the processor to display results of the discovery operations.

34. The apparatus of claim 33 wherein the short-range wireless protocol conforms to a Bluetooth standard protocol.

35. The apparatus of claim 33 wherein the shared service comprises initiating a Voice over IP (VoIP) call using the remote device to provide access to an IP-enabled network.

36. The apparatus of claim 33 wherein the shared service comprises providing network access using the remote device.

37. A system comprising:
a first transceiver to communicate using a cellular communications protocol having a substantially omni-directional antenna;
a second transceiver to communicate using a short-range wireless communications protocol;
a button;
a processor coupled with the first transceiver, with the second transceiver and with the button to determine whether a remote device capable communicating using the short range wireless communications protocol is within range in response to activation of the button, wherein the processor causes discovery operations to be performed on the remote device, if any, to determine whether the remote device is capable of sharing services; and
a display device coupled with the processor to display results of the discovery operations.

38. The system of claim 37 wherein the short-range wireless protocol conforms to a Bluetooth standard protocol.

39. The system of claim 37 wherein the shared service comprises initiating a Voice over IP (VoIP) call using the remote device to provide access to an IP-enabled network.
